(19) United States
(12) Patent Application Publication
(10) Pub. No.: US 2025/0130137 A1
(43) Pub. Date: Apr. 24, 2025

(54) ESTIMATION METHOD, MEASUREMENT METHOD, AND INFORMATION PROCESSING DEVICE

(71) Applicant: FUJIKURA LTD., Tokyo (JP)

(72) Inventor: Satoshi Matsunaga, Chiba (JP)

(73) Assignee: FUJIKURA LTD., Tokyo (JP)

(21) Appl. No.: 18/685,602

(22) PCT Filed: Aug. 25, 2022
(86) PCT No.: PCT/JP2022/032066

§ 371 Date: Feb. 22, 2024

(30) Foreign Application Priority Data
Aug. 25, 2021 (JP) 2021-137474

(51) Int. Cl. G01M 11/00

(52) U.S. Cl. CPC G01M 11/338

(57) ABSTRACT

An estimation method includes estimating, using a relational equation, a measurement variation in a group delay from one or both of a loss in a target optical fiber and a power of a target light source. The group delay occurs when light generated by the target light source is inputted into the target optical fiber.

### BACKGROUND

### Technical Field

The present invention relates to an estimation method for estimating a measurement variation in a group delay in an optical fiber. Further, the present invention relates to a measurement method for measuring a physical quantity indicative of an optical characteristic of an optical fiber with use of the estimation method. Furthermore, the present invention relates to an information processing device for performing the estimation method or the measurement method.

### Description of the Related Art

A wavelength dispersion is one of typical physical quantities indicative of optical characteristics of an optical fiber. The wavelength dispersion can be measured with use of, for example, a phase-shift method.

The phase-shift method includes a measurement step, a regression step, and a calculation step. The measurement step is a step of measuring group delays τ1, τ2, . . . , τn at wavelengths λ1, λ2, . . . , λn. The regression step is a step of determining a regression equation τ=τ(λ) in which an explanatory variable is a wavelength λ and an objective variable is a group delay τ that occurs when light having the wavelength λ is inputted into an optical fiber. The determination of the regression equation τ=τ(λ) is made through a least-square method with reference to the group delays τ1, τ2, . . . , τn at the wavelengths λ1, λ2, . . . , λn which have been obtained in the measurement step. As the regression equation τ=τ(λ), for example, the Sellmeier equation τ=A+Bλ²+Cλ⁻² is used. The calculation step is a step of calculating a wavelength dispersion D(λ) with use of the regression equation τ=τ(λ) obtained in the regression step. The wavelength dispersion D(λ) is defined by D(λ)=dτ/dλ and thus can be calculated according to D(λ)=2Bλ−2Cλ⁻³ from the coefficients B and C in the Sellmeier equation.

Note that, in the calculation step, a physical quantity other than the wavelength dispersion D(λ) can be also calculated. For example, a zero-dispersion wavelength λ₀ defined as a solution to D(λ₀)=0 can be calculated according to λ₀=(C/B)^{1/4} from the coefficients B and C of the Sellmeier equation. In addition, on the basis of slope@λ₀=dD/dλ(λ₀), a zero-dispersion slope slope@λ₀ can be calculated according to slope@λ0=8B from the coefficient B of the Sellmeier equation. For example, Patent Literature 1 discloses a method for measuring a wavelength dispersion, a zero-dispersion wavelength, and a wavelength dispersion slope with use of the Sellmeier equation.

### Patent Literature

Patent Literature 1: Japanese Patent Publication No. 2002-236078

However, a longer optical fiber, due to noise, results in a greater a measurement variation in group delay. This decreases accuracy of a regression equation obtained in the regression step. As a result, accuracy of a physical quantity obtained in the calculation step is decreased. For example, in a single-mode fiber of IEC Type B1, the decrease in accuracy of a physical quantity arises in a case where its total length is longer than 156 km.
(a) of FIG. 9 shows a graph which plots a group delay (normalized relative group delay) at each wavelength obtained through daily measurement. (b) of FIG. 9 shows a graph which plots a difference in a group delay at each wavelength obtained through daily measurement from the average value at the wavelength. FIG. 9 indicates a tendency that a measurement variation in group delay is larger at both ends of the illustrated wavelength band and is smaller at a center of the illustrated wavelength band. It is clear that such a tendency decreases accuracy of the regression equation obtained in the regression step.

In order to improve accuracy of the regression equation, it is effective to determine a regression equation through a weighted least-square method using a weight corresponding to a measurement variation in the group delay at each wavelength. However, there has been no known method for theoretically identifying the measurement variation in group delay. In addition, in order to experimentally identify the measurement variation in group delay, measurement of the group delay needs to be repeated. This is troublesome and time-consuming. Therefore, it is unpractical that, every time a measurement-target optical fiber is changed, the measurement variation in group delay is experimentally identified.

### SUMMARY

One or more embodiments achieve (i) an estimation method for estimating a measurement variation in a group delay in an optical fiber, (ii) a measurement method for measuring a physical quantity indicative of an optical characteristic of the optical fiber with use of the estimation method, (iii) an information processing device for performing the estimation method, or (iv) an information processing device for performing the measurement method.

An estimation method in accordance with one or more embodiments includes an estimation step of estimating, with use of a predetermined relational equation, a measurement variation in a group delay that occurs when light generated by a light source (a target light source) is inputted into an optical fiber (a target optical fiber), from one or both of a loss in the optical fiber and a power of the light source.

Further, a measurement method in accordance with one or more embodiments includes an estimation step of estimating a measurement variation in a group delay that occurs when light generated by a light source (a target light source) is inputted into an optical fiber (a target optical fiber), from a wavelength of the light, with use of a relational equation corresponding to a fiber length of the optical fiber.

According to one or more embodiments, it is possible to achieve an estimation method for estimating a measurement variation in group delay in an optical fiber. In addition, according to one or more embodiments, it is possible to achieve a measurement method for measuring a physical quantity indicative of an optical characteristic of an optical fiber with use of the estimation method. In addition, according to one or more embodiments, it is possible to achieve an information processing device for performing the estimation method. In addition, according to one or more embodiments, it is possible to achieve an information processing device for performing the measurement method.

### BRIEF DESCRIPTION OF THE DRAWINGS

FIG. 1 is a flowchart illustrating a configuration of an estimation method in accordance with one or more embodiments.

FIG. 2 is a flowchart illustrating a specific example of a preparation step included in the estimation method illustrated in FIG. 1.

FIG. 3 is a graph illustrating an example of a power obtained in a first measurement step included in the preparation step illustrated in FIG. 2.

FIG. 4 is a graph illustrating an example of a loss obtained in a first measurement step included in the preparation step illustrated in FIG. 2.

FIG. 5 is a graph illustrating an example of a measurement variation in group delay obtained in a second measurement step included in the preparation step illustrated in FIG. 2.

FIG. 6 is a graph which plots pairs of: measurement variations (actually measured values) in group delay which are obtained in a second measurement step included in the preparation step illustrated in FIG. 2; and measurement variations (estimation values) in group delay which are obtained with use of a regression equation obtained in a regression step illustrated in FIG. 2.

FIG. 7 is a flowchart illustrating a configuration of a measurement method in accordance with one or more embodiments.

FIG. 8 is a block diagram illustrating a configuration of an information processing device in accordance with one or more embodiments.

FIG. 9 shows a graph which plots a group delay (normalized relative group delay) at each wavelength obtained through daily measurement and a graph which plots a difference in a group delay at each wavelength obtained through daily measurement from the average value at the wavelength.

FIG. 10 is a graph illustrating an example of standard deviations of group delays.

### DESCRIPTION OF THE EMBODIMENTS

### (Flow of Estimation Method)

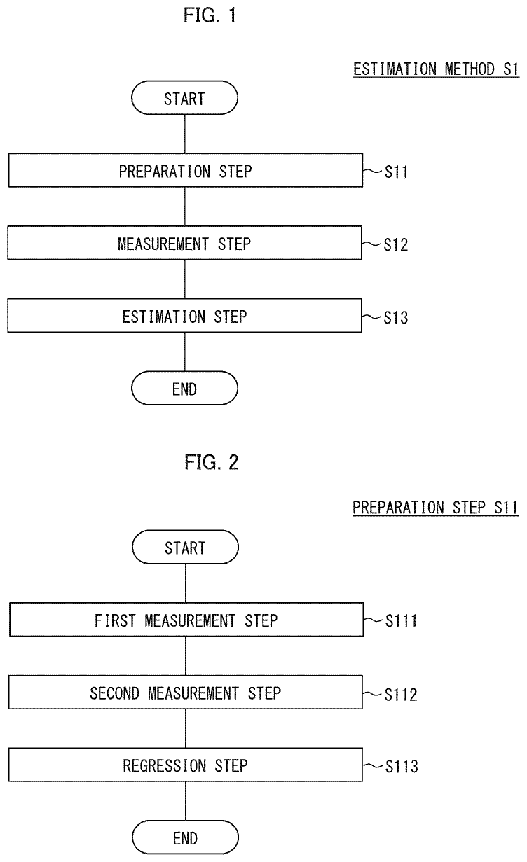

With reference to FIG. 1, the following description will discuss a flow of an estimation method S1 in accordance with one or more embodiments. FIG. 1 is a flowchart illustrating a flow of the estimation method S1.

As illustrated in FIG. 1, the estimation method S1 includes a preparation step S11, a measurement step S12, and an estimation step S13.

The preparation step S11 is a step of preparing a relational equation Δ=Δ(L,P) for deriving, from a loss L in an optical fiber and a power P of a light source, a measurement variation Δ in the group delay τ that occurs when light generated by the light source is inputted into the optical fiber. A specific example of the preparation step S11 will be discussed later with reference to another drawing. The group delay may be an absolute group delay or may be a relative group delay. In one or more embodiments, the relative group delay is used. In addition, the measurement variation may be a standard deviation of measurement values or may be a variance of measurement values. In one or more embodiments, the standard deviation is used.

The measurement step S12 is a step of measuring: a loss L_{OF} in an optical fiber to be subjected to optical-characteristic measurement (hereinafter, referred to as “optical fiber OF”); and a power P_{LS} of a light source used for the optical-characteristic measurement (hereinafter, referred to as “light source LS”). The loss L_{OF} can be measured through any method. In one or more embodiments, an OTDR method is used. Instead of the OTDR method, a cutback method may be used to measure the loss L_{OF}. The loss L_{OF} can be obtained by multiplying, by the length of the optical fiber OF, a loss value per unit length obtained through the OTDR method or the cutback method. The power P_{LS} can be measured through any method. Note that, in a case where the estimation method S1 is performed with use of an information processing device 1 described later, the information processing device 1 executes an acquisition step of acquiring the loss L_{OF} and the power P_{LS}. In the acquisition step, the information processing device 1 may acquire the loss L_{OF} and the power P_{LS} that have been inputted by a user with use of an input device connected to the information processing device 1 or may acquire the loss L_{OF} and the power P_{LS} through communication from a measurement device connected to the information processing device 1.

The estimation step S13 is a step of estimating, with use of the relational equation Δ=Δ(L,P) which has been obtained in the preparation step S11, a measurement variation Δ_{OF,LS} in the group delay τ which occurs when light generated by the light source LS is inputted into the optical fiber OF, from the loss L_{OF} and the power P_{LS} which have been obtained in the measurement step S12. Specifically, the loss L_{OF} and the power P_{LS} are substituted into the relational equation Δ=Δ(L,P), so as to obtain the measurement variation Δ_{OF,LS}=Δ(L_{OF},P_{LS}) in group delay.

Note that, in a case where the relational equation Δ=Δ(L,P) is prepared in advance, the preparation step S11 can be omitted. For example, in a case where the estimation method S1 is performed for a plurality of optical fibers having similar optical characteristics, the estimation method S1 performed for the second and subsequent optical fibers can omit the preparation step S11. This is because, in the estimation method S1 performed for the second and subsequent optical fibers, it is possible to use the relational equation Δ=Δ(L,P) which has been obtained in the preparation step S11 for the first optical fiber. Note that, in a case where the loss L_{OF} to be substituted into the relational equation Δ=Δ(L,P) falls within a domain of a function of the relational equation Δ=Δ(L,P) (range of the loss L), the domain of a function of the relational equation Δ=Δ(L,P) needs to be expanded by extrapolation. As a result, estimation accuracy may be decreased. In order to prevent such a decrease in estimation accuracy, the relational equation Δ=Δ(L,P) is preferably prepared with reference to a sufficiently broad range of the loss L so that the domain of a function of the relational equation Δ=Δ(L,P) includes the losses L_{OF} of the second and subsequent optical fibers. Alternatively, it is possible that a plurality of relational equations Δ=Δ(L,P) having different domains of a function are prepared in advance, and a relational equation Δ=Δ(L,P) whose domain of a function includes the losses L_{OF} of the second and subsequent optical fibers is selected and used. Here, a loss L per unit length in an optical fiber at each wavelength may be uniform within a range of a production error or may be non-uniform. Further, in the preparation step S11 and the measurement step S12, the loss L in the optical fiber may be uniform within a range of a production error or may be non-uniform. In addition, a power P of a light source at each wavelength may be uniform within a range of a production error or may be non-uniform. Further, in the preparation step S11 and the measurement step S12, the power P of the light source may be uniform within a range of a production error or may be non-uniform. Note that at least one of the loss L in the optical fiber and the power P of the light source is non-uniform.

Note that the estimation method S1 may be performed only in a case where the fiber length of the optical fiber falls within a predetermined range. For example, in a case where a measurement variation in group delay is not an issue in an optical fiber having a fiber length shorter than a predetermined length (for example, shorter than 156 km), the estimation method S1 may be performed only in a case where an optical fiber has a fiber length which is not less than the predetermined length. Alternatively, in a case where measurement variation in group delay is not an issue in an optical fiber having a fiber length shorter than a predetermined first length (for example, shorter than 156 km) and in a case where the relational equation Δ=Δ(L,P) becomes ineffective in an optical fiber having a fiber length longer than a predetermined second length (for example, longer than 180 km), the estimation method S1 may be performed only in a case where an optical fiber has a fiber length which is not less than the first length and not more than the second length.

### (Specific Example of Preparation Step)

With reference to FIG. 2, the following description will discuss one specific example of the preparation step S11 included in the estimation method S1. FIG. 2 is a flowchart illustrating the specific example of the preparation step S11. The preparation step S11 is performed with use of an optical fiber which is the same or same in type as the optical fiber OF (hereinafter, referred to as “optical fiber OF′”) and a light source which is the same or same in type as the light source LS (hereinafter, referred to as “light source LS′”).

Note that, in the preparation step S11, as the above-described relational equation Δ=Δ(L,P), a regression equation is obtained in which objective variables are the loss L in an optical fiber and the power P of a light source and an explanatory variable is a measurement variation Δ in the group delay τ that occurs when light generated by the light source is inputted into the optical fiber. Therefore, the above-described relational equation Δ=Δ(L,P) is herein also referred to as a regression equation Δ=Δ(L,P).

As illustrated in FIG. 2, the preparation step S11 includes a first measurement step S111, a second measurement step S112, and a regression step S113.

The first measurement step S111 is a step of measuring a loss Li in the optical fiber OF′ at each of a plurality of wavelengths λ1, λ2, . . . , λn differing from each other and a power Pi of the light source LS′ at each of the plurality of wavelengths λ1, λ2, . . . , λn. Here, n is any natural number of not less than 2. Further, i is any natural number of not less than 1 and not more than n. The loss Li represents a loss in the optical fiber OF′ at a wavelength λi, and the power Pi represents a power of the light source LS′ at the wavelength λi. The losses L1, L2, . . . , Ln can be measured through any method. In one or more embodiments, the OTDR method is used. Instead of the OTDR method, the cutback method may be used to measure the losses L1, L2, . . . , Ln. The powers P1, P2, . . . , Pn can be measured through any method. Note that, in a case where the estimation method S1 is performed with use of the information processing device 1 described later, the information processing device 1 executes a first acquisition step of acquiring the loss Li and the power Pi. In the first acquisition step, the information processing device 1 may acquire the loss Li and the power Pi that have been inputted by a user with use of an input device connected to the information processing device 1 or may acquire the loss Li and the power Pi through communication from a measurement device connected to the information processing device 1.

The second measurement step S112 is a step of repeatedly measuring, with respect to each of the plurality of wavelengths λ1, λ2, . . . , λn, a group delay Ti that occurs when light generated by the light source LS′ is inputted into the optical fiber OF′ and calculating a measurement variation Δi in the group delay τi from a plurality of measurement values thus obtained. Here, the group delay τi represents a group delay in the optical fiber OF′ at the wavelength λi. The group delay τi can be measured through any method. In one or more embodiments, the phase-shift method is used. Note that, in a case where the estimation method S1 is performed with use of the information processing device 1 described later, the information processing device 1 executes a second acquisition step of acquiring the group delay τi. In the second acquisition step, the information processing device 1 may acquire the group delay τi that has been inputted by a user with use of an input device connected to the information processing device 1 or may acquire the group delay τi through communication from a measurement device connected to the information processing device 1.

The regression step S113 is a step of determining a regression equation Δ=Δ(L,P) in which explanatory variables are the loss L in the optical fiber and the power P of the light source and an objective variable is the measurement variation Δ in the group delay τ that occurs when light generated by the light source is inputted into the optical fiber. The determination of the regression equation Δ=Δ(L,P) is made with reference to (i) the losses L1, L2, . . . , Ln which have been obtained in the first measurement step S111, (ii) the powers P1, P2, . . . , Pn which have been obtained in the first measurement step S111, and (iii) the measurement variations Δ1, Δ2, . . . , Δn which have been obtained in the second measurement step S112. The least-square method is used for the determination of the regression equation Δ=Δ(L,P). That is, the coefficients included in the regression equation Δ=Δ(P,L) are determined so as to minimize Σ{Δ(Li,Pi)−Δi}². Here, Σ represents a sum across i=1, 2, . . . , n. The regression equation Δ=Δ(P,L) is not particularly limited. In one or more embodiments, log(Δ)=αP+βL+γ, that is, Δ=exp(αP+βL+γ) is used as the regression equation Δ=Δ(P,L).

### (Example of Preparation Step)

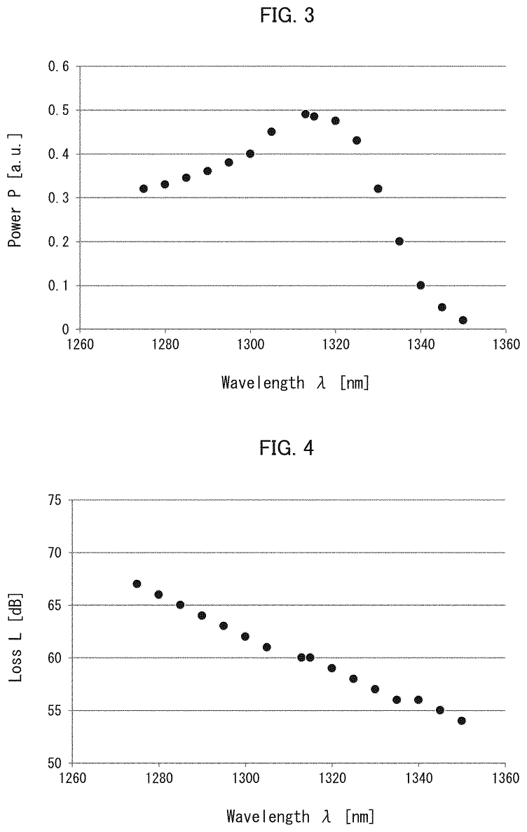

With reference to FIGS. 3 to 6, the following description will discuss an example of the preparation step S11 illustrated in FIG. 2.

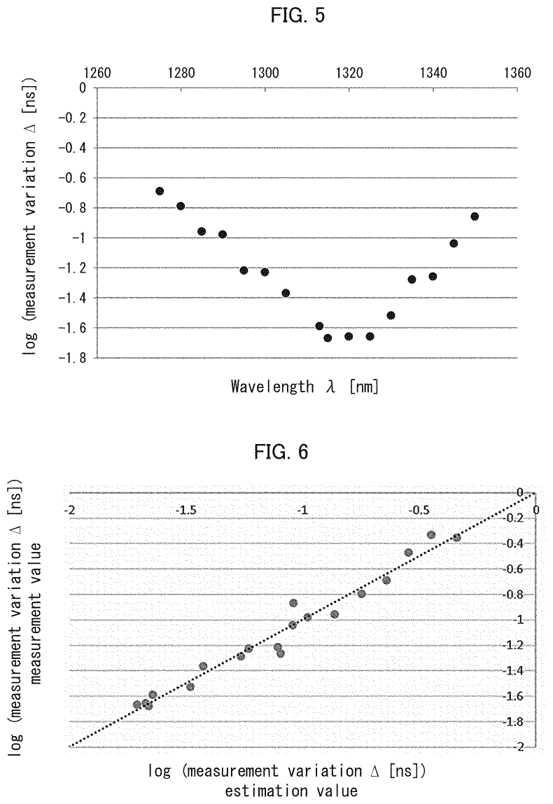

FIG. 4 is a graph illustrating one example of the loss Li (an entire loss obtained by measuring a loss per unit length and multiplying the loss per unit length by a fiber length) obtained in the first measurement step S111. FIG. 3 is a graph illustrating one example of the power Pi obtained in the first measurement step S111. FIG. 5 is a graph illustrating one example of the measurement variation Δi in the group delay τi obtained in the second measurement step S112. Note that some of the losses Li illustrated in FIG. 3 are actually measured values and the others are sweep values based on a loss model.

The regression step S113 was performed with use of the losses L1, L2, . . . , Ln illustrated in FIG. 4, the powers P1, P2, . . . , Pn illustrated in FIG. 3, and the measurement variations Δ1, Δ2, . . . , Δn of the group delay τi illustrated in FIG. 5. As a result, the coefficients of the regression equation log(A)=αP+βL+γ were determined as follows.

α=−2.39, β=0.08650, γ=−5.67.

FIG. 6 is a graph which plots pairs of: the measurement variations Δi (actually measured values) of the group delay τi which have been obtained in the second measurement step S112; and measurement variations Δ(Li,Pi) (estimation values) in the group delay τi which have been obtained with use of the regression equation log(Δ)=αP+βL+γ. FIG. 6 indicates that the plots are located near a diagonal line (dotted line). This means that the estimation values suitably approximate the actually measured values.

### (Flow of Measurement Method)

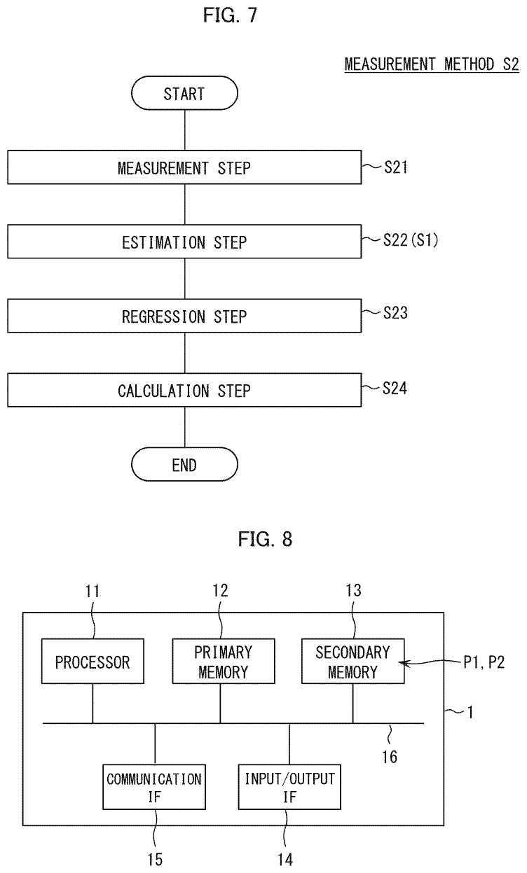

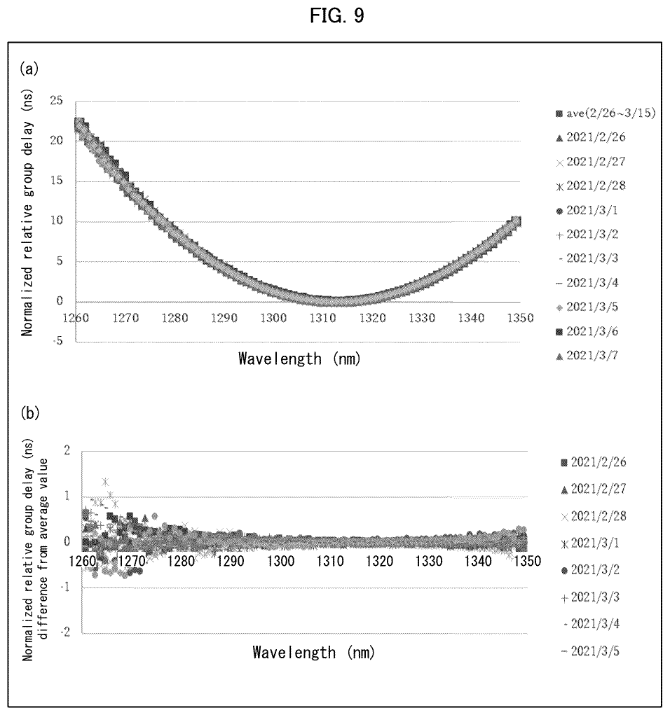

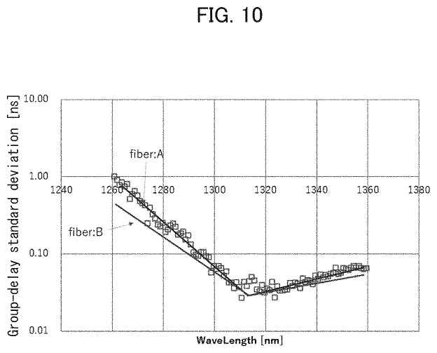

With reference to FIG. 7, the following description will discuss a flow of a measurement method S2 in accordance with one or more embodiments. FIG. 7 is a flowchart illustrating a flow of the measurement method S2.

As illustrated in FIG. 7, the measurement method S2 includes a measurement step S21, an estimation step S22, a regression step S23, and a calculation step S24.

The measurement step S21 is a step of measuring, with respect to each of a plurality of wavelengths λ1, λ2, . . . , λm differing from each other, a group delay τj that occurs when light generated by the light source LS is inputted to the optical fiber OF. Here, m is any natural number of not less than 2. In addition, the group delay τj represents a group delay in the optical fiber OF at the wavelength λj (j=1, 2, . . . , m). The group delay τj can be measured through any method. In one or more embodiments, the phase-shift method is used. Note that, in a case where the measurement method S2 is performed with use of the information processing device 1 described later, the information processing device 1 executes an acquisition step of acquiring the group delay τj. In the acquisition step, the information processing device 1 may acquire the group delay τj that has been inputted by a user with use of an input device connected to the information processing device 1 or may acquire the group delay τj through communication from a measurement device connected to the information processing device 1.

The estimation step S22 is a step of estimating, with respect to each of the plurality of wavelengths λ1, λ2, . . . , λm, a measurement variation Δj in the group delay τj that occurs when light generated by the light source LS is inputted into the optical fiber OF. The estimation step S22 is carried out by performing the above-described estimation method S1 with respect to each of the plurality of wavelengths λ1, λ2, . . . , λm.

The regression step S23 is a step of determining, with reference to the group delays τ1, τ2, . . . , τm which have been obtained in the measurement step S21, a regression equation τ=τ(λ) in which an explanatory variable is the wavelength λ and an objective variable is a group delay τ that occurs when light having the wavelength λ is inputted into an optical fiber. The determination of the regression equation τ=τ(λ) is made with use of the least-square method using a weight wj corresponding to the measurement variation Δj which has been estimated in the estimation step S22. That is, the coefficients included in the regression equation τ=τ(λ) are determined so as to minimize Σwj{τ(λj)−τj}². Here, E represents a sum across j=1, 2, . . . , m. The regression equation τ=τ(λ) is not particularly limited. In one or more embodiments, the trinomial Sellmeier equation T=A+Bλ²+Cλ⁻² is used as the regression equation τ=τ(λ). As the regression equation τ=τ(λ), the pentanomial Sellmeier equation τ=A+Bλ²+Cλ⁻²+Dλ⁴+Eλ⁻⁴ may be used. Alternatively, a quadratic polynomial equation, a cubic polynomial equation, or a quartic polynomial equation may be used as the regression equation τ=τ(λ). In a case where, as the measurement variation Δj, a standard deviation σj or a variance σj² is used, as the weight wj, for example, 1/σj² can be used.

The calculation step S24 is a step of calculating a physical quantity indicative of an optical characteristic of the optical fiber OF with use of the regression equation τ=τ(λ) which has been obtained in the regression step S23. For example, in a case where the wavelength dispersion D(λ) of the optical fiber OF is a measurement target, the wavelength dispersion D(λ) is calculated according to D(λ)=2Bλ−2Cλ⁻³ from the coefficients B and C of the trinomial Sellmeier equation. Alternatively, in a case where the zero-dispersion wavelength λ₀ of the optical fiber OF is calculated, the zero-dispersion wavelength λ₀ is calculated according to λ₀=(C/B)^{1/4} from the coefficients B and C of the trinomial Sellmeier equation. Alternatively, in a case where the zero-dispersion slope slope@λ₀ of the optical fiber OF is a measurement target, the zero-dispersion slope slope@λ₀ is calculated according to slope@λ₀=8B from the coefficient B of the trinomial Sellmeier equation. Note that, in a case where the pentanomial Sellmeier equation is used as the regression equation τ=τ(λ), the wavelength dispersion D(λ) can be calculated according to D(λ)=2Bλ−2Cλ⁻³+4Dλ³−4Eλ⁻⁵ from the coefficients B, C, D, and E of the pentanomial Sellmeier equation.

### (Configuration of Information Processing Device)

With reference to FIG. 8, the following description will discuss a configuration of the information processing device 1 in accordance with one or more embodiments. FIG. 8 is a block diagram illustrating a configuration of the information processing device 1.

The information processing device 1 is achieved with use of a general-purpose computer and includes a processor 11, a primary memory 12, a secondary memory 13, an input/output interface 14, a communication interface 15, and a bus 16. The processor 11, the primary memory 12, the secondary memory 13, the input/output interface 14, and the communication interface 15 are connected with each other via the bus 16.

The secondary memory 13 stores an estimation program P1 and a measurement program P2. The processor 11 loads, on the primary memory 12, the estimation program P1 stored in the secondary memory 13. The processor 11 then executes the steps included in the estimation method S1 in accordance with instructions included in the estimation program P1 loaded on the primary memory 12. Further, the processor 11 loads, on the primary memory 12, the measurement program P2 stored in the secondary memory 13. The processor 11 then executes the steps included in the measurement method S2 in accordance with instructions included in the measurement program P2 loaded on the primary memory 12. Note that, in the measurement steps included in the estimation method S1 and the measurement method S2, the processor 11 executes steps of acquiring measurement values from a measurement device or an input device rather than executing the measurement itself.

Examples of a device usable as the processor 11 include a central processing unit (CPU), a graphic processing unit (GPU), a digital signal processor (DSP), a micro processing unit (MPU), a floating point number processing unit (FPU), a physics processing unit (PPU), a microcontroller, or any combination thereof. The processor 11 may also be referred to as “calculation device”.

Examples of a device usable as the primary memory 12 include a random access memory (RAM). The primary memory 12 may be referred as “main storage device”. Examples of a device usable as the secondary memory 13 include a flash memory, a hard disk drive (HDD), a solid state drive (SSD), an optical disk drive (ODD), or any combination thereof. The secondary memory 13 may be referred to as “auxiliary storage device”. Note that the secondary memory 13 may be included in the information processing device 1 or may be included in another computer (for example, a computer constituting a cloud server) which is connected to the information processing device 1 via the input/output interface 14 or the communication interface 15. Note that, in one or more embodiments, storage in the information processing device 1 is achieved by two memories (the primary memory 12 and the secondary memory 13), but the present invention is not limited to this. That is, the storage in the information processing device 1 may be achieved by a single memory. In this case, for example, one storage area of the single memory may be used as the primary memory 12, and another storage area of the single memory may be used as the secondary memory 13.

To the input/output interface 14, an input device and/or an output device is/are connected. Examples of the input/output interface 14 include interfaces such as a universal serial bus (USB), an advanced technology attachment (ATA), a small computer system interface (SCSI), and a peripheral component interconnect (PCI). Examples of the input device connected to the input/output interface 14 include measurement devices. In a case where the measurement values which have been measured in each of the measurement steps included in the estimation method S1 and the measurement method S2 are inputted automatically, the processor 11 acquires these measurement values from the measurement device via the input/output interface 14 and stores the measurement values in the primary memory 12. Further, examples of the input device connected to the input/output interface 14 include a keyboard, a mouse, a touchpad, a microphone, or any combination thereof. In a case where the measurement values which have been measured in each of the measurement steps included in the estimation method S1 and the measurement method S2 are inputted manually, the processor 11 acquires these measurement values from the input device via the input/output interface 14 and stores the measurement values in the primary memory 12. Examples of the output device connected to the input/output interface 14 include a display, a projector, a printer, a speaker, a headphone, or any combination thereof. The information (for example, an estimation result and a measurement result) provided to the user in the estimation method S1 and the measurement method S2 is outputted from the information processing device 1 via these output devices. Note that, as in the case of a laptop computer, the information processing device 1 may include each of a keyboard serving as an input device and a display serving as an output device. Alternatively, as in the case of a tablet computer, the information processing device 1 may include a touch panel serving as both the input device and the output device.

To the communication interface 15, another computer is connected via a network in a wired manner or wirelessly. Examples of the communication interface 15 include interfaces such as Ethernet (registered trademark) and Wi-Fi (registered trademark). Examples of a usable network include a personal area network (PAN), a local area network (LAN), a campus area network (CAN), a metropolitan area network (MAN), a wide area network (WAN), a global area network (GAN), or an internetwork including a combination thereof. The internetwork may be an intranet, or may be an extranet, or may be the Internet. Data that the information processing device 1 acquires from another computer in the estimation method S1 and the measurement method S2 and data that the information processing device 1 provides to another computer in the estimation method S1 are transmitted/received via these network.

Note that, in one or more embodiments, a configuration is employed in which a single processor (the processor 11) is used to execute the estimation method S1. However, the present invention is not limited to this. That is, it is alternatively possible to employ a configuration in which a plurality of processors are used to execute the estimation method S1. In this case, the plurality of processors that work together to execute the estimation method S1 may be provided in a single computer and be configured to be communicable with each other via a bus or may be dispersedly provided in a respective plurality of computers and be configured to be communicable with each other via a network. For example, it is possible that a processor included in a computer constituting a cloud server and a processor included in a computer owned by a user of the cloud server work together to execute the estimation method S1. The same applies to the measurement method S2.

One or more embodiments employ a configuration in which the estimation program P1 is stored in a memory (the secondary memory 13) included in a computer that includes a processor (the processor 11) for executing the estimation method S1. However, the present invention is not limited to this. That is, it is possible to employ a configuration in which the estimation program P1 is stored in a memory included in a computer different from one which includes the processor for executing the estimation method S1. In this case, the computer including the memory for storing the estimation program P1 and the computer including the processor for executing the estimation method S1 are configured to be communicable with each other via a network. For example, it is possible that the estimation program P1 is stored in a memory included in a computer constituting a cloud server, and a processor included in a computer owned by a user of the cloud server executes the estimation method S1. The same applies to the measurement method S2 and the measurement program P2.

(Support for Optical Fibers with Different Fiber Lengths)

The experiment that has been conducted by the inventors of the present invention shows that wavelength dependency of the measurement variation in group delay (group-delay standard deviation) differs depending on the fiber length of an optical fiber. FIG. 10 is a graph illustrating the results of the experiment. Here, with respect to an optical fiber A (in FIG. 10, expressed as “fiber: A”) and an optical fiber B (in FIG. 10, expressed as “fiber: B”) which is longer than the optical fiber A, the wavelength dependency of measurement variations in group delay is illustrated. This suggests that it is preferable that relational equations Δ=Δ(L,P) to be used in the estimation method S1 are selected individually for different fiber lengths.

More specifically, in the estimation method S1, the preparation step S11 including the first measurement step S111, the second measurement step S112, and the regression step S113 is preferably performed for a plurality of optical fibers having different fiber lengths. In addition, in the estimation step S13 in the estimation method S1, it is preferable to use, among the regression equations which have been obtained in the regression step S113 and which correspond to the plurality of optical fibers, a regression equation which corresponds to the optical fiber which has the fiber length closest to that of the optical fiber to be estimated or in which the loss is the closest to the loss of an optical fiber to be estimated. This makes it possible to more accurately estimate a variation in group delay. Note that, it is because of the presence of a positive correlation between the fiber length and the loss that, even in a case where the regression equation corresponding to the optical fiber in which the loss is the closest to the loss of an optical fiber to be estimated is used, a result can be obtained which is the same as that obtained in a case where the regression equation corresponding to the optical fiber having the fiber length closest to that of an optical fiber to be estimated is used.

### VARIATION

In a case where a power of a light source at each wavelength is uniform within a production error and in a case where a loss per unit length in an optical fiber at each wavelength is uniform within a production error, the wavelength dependency of the measurement variation in group delay is determined depending on a fiber length FL of an optical fiber. In this case, it is possible to change the above-described preparation step S11 in the estimation method S1 to a preparation step S11 including a measurement step below and a regression step below. Here, in the preparation step S11 and the measurement step S12, a power of a light source at each wavelength is uniform within a production error. In addition, in the preparation step S11 and the measurement step S12, a loss per unit length in an optical fiber at each wavelength is uniform within a production error.

The measurement step is a step of repeatedly measuring, with respect to each of a plurality of fiber lengths FL1, FL2, . . . , FLm and each of a plurality of wavelengths λ1, λ2, . . . , λn, a group delay τji that occurs when light having a wavelength λi (i is a natural number of not less than 1 and not more than n) is inputted into an optical fiber having a fiber length FLj (j is a natural number of not less than 1 and not more than m) and calculating a measurement variation Δji in the group delay τji from a plurality of measurement values thus obtained. Note that, in a case where the estimation method S1 in accordance with the present variation is performed with use of the above-described information processing device 1, the information processing device 1 executes an acquisition step of acquiring the group delay τji. In the acquisition step, the information processing device 1 may acquire the group delay τji that has been inputted by a user with use of an input device connected to the information processing device 1 or may acquire the group delay τji through communication from a measurement device connected to the information processing device 1.

The regression step is a step of determining, with respect to each of the plurality of fiber lengths FL1, FL2, . . . , FLm, a regression equation Δj=Δj(λ) in which an explanatory variable is a wavelength λ and an objective variable is a measurement variation Δj in a group delay that occurs when light having a wavelength λ is inputted into an optical fiber having a fiber length FLj. The determination of the regression equation Δj=Δj(λ) is made with reference to the measurement variations Δj1, Δj2, . . . , Δjn which have been obtained in the measurement step (acquisition step). The least-square method is used for the determination of the regression equation Δj=Δj(λ). That is, the coefficients included in the regression equation Δj=Δj(λ) are determined so as to minimize Σ{Δj(λi)−Δji}². Here, E represents a sum across i=1, 2, . . . , n. The regression equation Δj=Δj(λ) is not particularly limited. In the present variation, as the regression equation Δj=Δj(λ), Δj=αj×exp(βⱼ×λ) is used.

In this case, in the measurement step S12 in the estimation method S1, the fiber length FL_{OF} of the optical fiber OF to be subjected to an optical-characteristic measurement is measured. In a case where the estimation method S1 is performed with use of the above-described information processing device 1, the information processing device 1 executes an acquisition step of acquiring the fiber length FL_{OF}. In the acquisition step, the information processing device 1 may acquire the fiber length FL_{OF} that has been inputted by a user with use of an input device connected to the information processing device 1 or may acquire the fiber length FL_{OF} through communication from a measurement device connected to the information processing device 1.

In this case, in the estimation step S13 in the estimation method S1, a measurement variation Δ_{λ0,OF} in the group delay τ that occurs when light having a wavelength λ₀ is inputted into the optical fiber OF is estimated with use of the relational equation Δ_{OF}=Δ_{OF}(λ) which has been obtained in the preparation step S11, from the fiber length FL_{OF} which has been obtained in the measurement step S12. Specifically, a measurement variation Δ_{OF}=Δ_{OF}(λ₀) in group delay is obtained by substituting the wavelength λ₀ into the relational equation Δ_{OF}=Δ_{OF}(λ). Here, the relational equation Δ_{OF}=Δ_{OF}(λ) is a regression equation corresponding to the fiber length closest to the fiber length FL_{OF} which has been obtained in the measurement step S12, among the plurality of regression equations Δ1=Δ1(λ), λ2=Δ2(λ), . . . , Δm=Δm(λ) which have been obtained in the above-described preparation step. For example, in a case where the fiber length closest to the fiber length FL_{OF} is FL1, the relational equation Δ_{OF}=Δ_{OF}(λ) is Δ1=Δ1(λ) and in a case where the fiber length closest to the fiber length FL_{OF} is FL2, the relational equation Δ_{OF}=Δ_{OF}(λ) is Δ2=Δ2(λ).

### (Recap 1)

An estimation method in accordance with Aspect 1 of one or more embodiments includes an estimation step of, with use of a predetermined relational equation, estimating a measurement variation in a group delay that occurs when light generated by a light source (a target light source) is inputted into an optical fiber (a target optical fiber), from one or both of a loss in the optical fiber and a power of the light source.

Note that the estimation method in accordance with Aspect 1 of one or more embodiments may further include an acquisition step of acquiring one or both of a loss in the optical fiber and a power of the light source. In this case, the estimation step may be a step of estimating the measurement variation in the group delay from one or both of the loss and the power which have been acquired in the acquisition step.

In an estimation method in accordance with Aspect 2 of one or more embodiments, in addition to an arrangement of Aspect 1, the estimation step is a step of estimating the measurement variation from one or both of the loss and the power with use of a relational equation which, among predetermined relational equations, corresponds to a fiber length of the optical fiber.

An estimation method in accordance with Aspect 3 of one or more embodiments further includes, in addition to an arrangement of Aspect 1, a first acquisition step of acquiring one or both of a loss in an optical fiber (a preparation subject optical fiber) at each of a plurality of wavelengths differing from each other and a power of a light source (a preparation subject light source) at each of the plurality of wavelengths; a second acquisition step of, with respect to each of the plurality of wavelengths, acquiring a plurality of measurement values obtained by repeatedly measuring a group delay that occurs when light generated by said light source is inputted into said optical fiber and calculating a measurement variation in the group delay from the plurality of measurement values; and a regression step of deriving a regression equation Δ=Δ(L,P) in which an explanatory variable is one or both of a loss L in an optical fiber and a power P of a light source and an objective variable is a measurement variation Δ in a group delay that occurs when light generated by said light source is inputted into said optical fiber, through a least-square method, with reference to the measurement variation which has been obtained in the second acquisition step and one or both of the loss and the power which have been obtained in the first acquisition step, wherein the relational equation used in the estimation step is the regression equation which has been obtained in the regression step.

An estimation method in accordance with Aspect 4 of one or more embodiments includes, in addition to an arrangement of Aspect 2: a first acquisition step of acquiring one or both of a loss in an optical fiber (a preparation subject optical fiber) at each of a plurality of wavelengths differing from each other and a power of a light source (a preparation subject light source) at each of the plurality of wavelengths; a second acquisition step of, with respect to each of the plurality of wavelengths, acquiring a plurality of measurement values obtained by repeatedly measuring a group delay that occurs when light generated by said light source is inputted into said optical fiber and calculating a measurement variation in the group delay from the plurality of measurement values; and a regression step of deriving a regression equation Δ=Δ(L,P) in which an explanatory variable is one or both of a loss L in an optical fiber and a power P of a light source and an objective variable is a measurement variation Δ in a group delay that occurs when light generated by said light source is inputted into said optical fiber, through a least-square method, with reference to the measurement variation which has been obtained in the second acquisition step and one or both of the loss and the power which have been obtained in the first acquisition step, the first acquisition step, the second acquisition step, and the regression step being performed on each of a plurality of optical fibers having different fiber lengths, wherein the relational equations are regression equations which have been obtained in the regression step and which correspond to the plurality of optical fibers, and the relational equation used in the estimation step is, among the relational equations, a regression equation corresponding to an optical fiber which has a fiber length closest to a fiber length of the optical fiber or in which a loss is the closest to a loss of the optical fiber.

A measurement method in accordance with Aspect 5 of one or more embodiments includes an estimation step of estimating a measurement variation in a group delay that occurs when light generated by a light source (a target light source) is inputted into an optical fiber (a target optical fiber), from a wavelength of the light, with use of a relational equation corresponding to a fiber length of the optical fiber.

A measurement method in accordance with Aspect 6 of one or more embodiments further includes, in addition to an arrangement of Aspect 5: an acquisition step of acquiring, with respect to each of a plurality of fiber lengths FL1, FL2, . . . , FLm and each of a plurality of wavelengths λ1, λ2, . . . , λn, a plurality of measurement values obtained by repeatedly measuring a group delay τji that occurs when light having a wavelength λi (i is a natural number of not less than 1 and not more than n) is inputted into an optical fiber having length FLj (j is a natural number of not less than 1 and not more than m) and calculating a variation Δji in the group delay from the plurality of measurement values; and a regression step of deriving, with respect to each of the plurality of fiber lengths FL1, FL2, . . . , FLm, a regression equation Δj=Δj(λ) in which an explanatory variable is a wavelength λ and an objective variable is a measurement variation Δj in a group delay that occurs when light having the wavelength λ is inputted into an optical fiber having the fiber length FLj, through a least-square method, with reference to measurement variations Δj1, Δj2, . . . , Δjn which have been obtained in the acquisition step, wherein the relational equation used in the estimation step is, among a plurality of regression equations Δ1=Δ1(λ), Δ2=Δ2(λ), . . . , Δm=Δm(λ) which have been obtained in the regression step, a regression equation corresponding to a fiber length which is the closest to the fiber length of the optical fiber.

In a measurement method in accordance with Aspect 7 of one or more embodiments, in addition to an arrangement of any one of Aspects 1 and 4 to 6, the estimation step is performed only in a case where the fiber length of the optical fiber falls within a predetermined range.

A measurement method in accordance with Aspect 8 of one or more embodiments includes: an acquisition step of acquiring, with respect to each of a plurality of wavelengths differing from each other, a group delay that occurs when light generated by a light source (a target light source) is inputted into an optical fiber (a target optical fiber); an estimation step of estimating a measurement variation in the group delay that occurs when light generated by the light source is inputted into the optical fiber, with use of the estimation method in accordance with any one of Aspects 1 to 7, with respect to each of the plurality of wavelengths differing from each other; a regression step of determining a regression equation τ=τ(λ) in which an explanatory variable is a wavelength λ and an objective variable is a group delay τ that occurs when light having the wavelength λ is inputted into an optical fiber, with reference to the group delay which has been obtained in the acquisition step, through a weighted least-square method using a weight corresponding to the measurement variation which has been obtained in the estimation step; and a calculation step of calculating a physical quantity indicative of an optical characteristic of the optical fiber with use of the regression equation τ=τ(λ) which has been obtained in the regression step.

In a measurement method in accordance with Aspect 9 of one or more embodiments, in addition to an arrangement of Aspect 8, the regression equation τ=τ(λ) is a Sellmeier equation τ=A+Bλ²+Cλ⁻².

In a measurement method in accordance with Aspect 10 of one or more embodiments, in addition to an arrangement of Aspect 9, the physical quantity is a wavelength dispersion D(λ), a zero-dispersion wavelength λ₀, or a zero-dispersion slope slope@λ₀, and the calculation step is a step of calculating the wavelength dispersion D(λ) according to D(λ)=2Bλ−2Cλ⁻³, aa step of calculating the zero-dispersion wavelength λ₀ according to λ₀=(C/B)^{1/4}, or a step of the zero-dispersion slope slope@λ₀ according to slope@λ₀=8B.

Note that the scope of the present invention also encompasses an information processing device for performing the estimation method in accordance with any one of Aspects 1 to 7 and an information processing device for performing the measurement method in accordance with any one of Aspects 8 to 10.

### (Recap 2)

An estimation method in accordance with Aspect 1 of one or more embodiments includes: a measurement step of measuring one or both of a loss in an optical fiber and a power of a light source; and an estimation step of estimating, with use of a predetermined relational equation, a measurement variation in a group delay that occurs when light generated by said light source is inputted into said optical fiber, from one or both of the loss and the power which have been obtained in the measurement step.

According to the above method, it is possible to estimate a measurement variation in group delay without repeatedly measuring the group delay.

In an estimation method in accordance with Aspect 2 of one or more embodiments an arrangement is employed of further including, in addition to an arrangement of Aspect 1: a first measurement step of measuring one or both of a loss in an optical fiber at each of a plurality of wavelengths differing from each other and a power of a light source at each of the plurality of wavelengths; a second measurement step of repeatedly measuring, with respect to each of the plurality of wavelengths, a group delay that occurs when light generated by the light source is inputted into the optical fiber and calculating a measurement variation in the group delay from a plurality of measurement values thus obtained; and a regression step of deriving a regression equation Δ=Δ(L,P) in which an explanatory variable is one or both of a loss L in an optical fiber and a power P of a light source and an objective variable is a measurement variation Δ in the group delay that occurs when light generated by said light source is inputted into said optical fiber, through a least-square method, with reference to the measurement variation which has been obtained in the second measurement step and one or both of the loss and the power which have been obtained in the first measurement step, wherein the relational equation is the regression equation Δ=Δ(L,P) which has been obtained in the regression step.

According to the above method, it is possible to estimate a measurement variation in group delay with use of the regression equation Δ=Δ(L,P).

A measurement method in accordance with Aspect 3 of one or more embodiments includes: a measurement step of measuring, with respect to each of a plurality of wavelengths differing from each other, a group delay that occurs when light generated by a light source is inputted into an optical fiber; an estimation step of estimating a measurement variation in the group delay that occurs when light generated by said light source is inputted into said optical fiber, with use of the estimation method in accordance with Aspect 1 or 2, with respect to each of the plurality of wavelengths differing from each other; a regression step of determining a regression equation τ=τ(λ) in which an explanatory variable is a wavelength λ and an objective variable is a group delay τ that occurs when light having the wavelength λ is inputted into an optical fiber, with reference to the group delay which has been obtained in the measurement step, through a weighted least-square method using a weight corresponding to the measurement variation which has been obtained in the estimation step; and a calculation step of calculating a physical quantity indicative of an optical characteristic of said optical fiber with use of the regression equation τ=τ(λ) which has been obtained in the regression step.

According to the above method, it is possible to accurately measure a physical quantity indicative of an optical characteristic of an optical fiber.

In a measurement method in accordance with Aspect 4 of one or more embodiments, in addition to an arrangement of Aspect 3, an arrangement is employed in which the regression equation τ=τ(λ) is a Sellmeier equation τ=A+Bλ²+Cλ⁻².

According to the above method, it is possible to easily determine an accurate regression equation τ=τ(λ).

In a measurement method in accordance with Aspect 5 of one or more embodiments, in addition to an arrangement of Aspect 4, an arrangement is employed in which the physical quantity is a wavelength dispersion D(λ), a zero-dispersion wavelength λ₀, or a zero-dispersion slope slope@λ₀, and the calculation step is a step of calculating the wavelength dispersion D(λ) according to D(λ)=2Bλ−2Cλ⁻³, a step of calculating the zero-dispersion wavelength λ₀ according to λ₀=(C/B)^{1/4}, or a step of the zero-dispersion slope slope@λ₀ according to slope@λ₀=8B.

According to the above method, it is possible to accurately measure a wavelength dispersion D(λ), a zero-dispersion wavelength λ₀, or a zero-dispersion slope slope@λ₀ of an optical fiber.

Note that the scope of the present invention also encompasses an information processing device for performing the estimation method in accordance with Aspect 1 or 2 and an information processing device for performing the measurement method in accordance with any one of Aspects 3 to 5.

### ADDITIONAL REMARKS

The present invention is not limited to the embodiments, but can be altered by a skilled person in the art within the scope of the claims. The present invention also encompasses, in its technical scope, other embodiments derived by combining technical means disclosed in the above embodiments as appropriate. Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

S1 Estimation method
S11 Preparation step
S111 First measurement step
S112 Second measurement step
S113 Regression step
S12 Measurement step
S13 Estimation step
S2 Measurement method
S21 Measurement step
S22 Estimation step
S23 Regression step
S24 Calculation step
1 Information processing device
11 Processor
12 Primary memory
13 Secondary memory
14 Input/output interface
15 Communication interface
16 Bus

1. An estimation method comprising:
estimating, using a relational equation, a measurement variation in a group delay from one or both of a loss in a target optical fiber and a power of a target light source, wherein
the group delay occurs when light generated by the target light source is inputted into the target optical fiber.

2. The estimation method according to claim 1, wherein the relational equation is a predetermined relational equation corresponding to a fiber length of the target optical fiber.

3. The estimation method according to claim 1, further comprising:
at each of a plurality of wavelengths differing from each other, acquiring one or both of:
an additional loss in a preparation subject optical fiber, and
an additional power of a preparation subject light source;
with respect to each of the plurality of wavelengths:
acquiring measurement values by repeatedly measuring an additional group delay that occurs when light generated by the preparation subject light source is inputted into the preparation subject optical fiber; and
calculating an additional measurement variation in the additional group delay from the measurement values; and
deriving a regression equation defined as Δ=Δ(L,P) in which an explanatory variable is one or both of a loss L in an optical fiber and a power P of a light source and an objective variable is a measurement variation Δ in a group delay that occurs when light generated by the light source is inputted into the optical fiber, through a least-square method, with reference to the additional measurement variation and one or both of the additional loss and the additional power, wherein
the relational equation is the regression equation.

4. The estimation method according to claim 2, comprising, on each of a plurality of optical fibers having different fiber lengths:
at each of a plurality of wavelengths differing from each other, acquiring one or both of:
an additional loss in a preparation subject optical fiber, and
an additional power of a preparation subject light source;
with respect to each of the plurality of wavelengths:
acquiring measurement values by repeatedly measuring an additional group delay that occurs when light generated by the preparation subject light source is inputted into the preparation subject optical fiber; and
calculating an additional measurement variation in the additional group delay from the measurement values; and
deriving a regression equation Δ=Δ(L,P) in which an explanatory variable is one or both of a loss L in an optical fiber and a power P of a light source and an objective variable is a measurement variation Δ in a group delay that occurs when light generated by the light source is inputted into the optical fiber, through a least-square method, with reference to the additional measurement variation and one or both of the additional loss and the additional power,
wherein
relational equations are regression equations obtained in the deriving of the regression equation and corresponding to the plurality of optical fibers, and
the relational equation is the regression equation corresponding to one of the plurality of optical fibers either that has a fiber length closest to the fiber length of the target optical fiber or in which a loss is the closest to the loss in the target optical fiber.

5. An estimation method comprising:
estimating, using a relational equation corresponding to a fiber length of a target optical fiber, a measurement variation in a group delay from a wavelength of light generated by a target light source, wherein,
the group delay occurs when the light is inputted into the target optical fiber.

6. The estimation method according to claim 5, further comprising:
with respect to each of a plurality of fiber lengths FL1, FL2, . . . , FLm and each of a plurality of wavelengths λ1, λ2, . . . , λn;
acquiring measurement values by repeatedly measuring a group delay τji that occurs when light having a wavelength λi (i is a natural number of not less than 1 and not more than n) is inputted into an optical fiber having a length FLj (is a natural number of not less than 1 and not more than m); and
calculating a variation Δji in the group delay τji from the measurement values; and
deriving, with respect to each of the plurality of fiber lengths FL1, FL2, . . . , FLm, a regression equation Δj=Δj(λ) in which an explanatory variable is a wavelength λ and an objective variable is a measurement variation Δj in a group delay that occurs when light having the wavelength λ is inputted into an optical fiber having the fiber length FLj, through a least-square method, with reference to measurement variations Δj1, Δj2, . . . , Δjn of the measurement values, wherein
the relational equation is, among regression equations Δ1=Δ1(λ), Δ2=Δ2(λ), . . . , Δm=Δm(λ) obtained in the deriving, a regression equation corresponding to a fiber length closest to the fiber length of the target optical fiber.

7. The estimation method according to claim 1, wherein the estimating of the measurement variation is performed only when the fiber length of the target optical fiber falls within a range.

8. A measurement method comprising:
acquiring, with respect to each of a plurality of wavelengths differing from each other, a group delay that occurs when light generated by a target light source is inputted into a target optical fiber;
with respect to each of the plurality of wavelengths, estimating, using a relational equation, a measurement variation in the group delay from one or both of a loss in the target optical fiber and a power of the target light source;
determining a regression equation τ=τ(λ) in which an explanatory variable is a wavelength λ and an objective variable is a group delay τ that occurs when light having the wavelength λ is inputted into an optical fiber, with reference to the acquired group delay, through a weighted least-square method using a weight corresponding to the estimated measurement variation; and
calculating a physical quantity indicative of an optical characteristic of the target optical fiber with the regression equation τ=τ(λ).

9. The measurement method according to claim 8, wherein the regression equation τ=τ(λ) is a Sellmeier equation τ=A+Bλ²+Cλ⁻².

10. The measurement method according to claim 9, wherein
the calculating of the physical quantity includes calculating a wavelength dispersion D(λ) according to D(λ)=2Bλ−2Cλ⁻³, a zero-dispersion wavelength λ₀ according to λ₀=(C/B)^{1/4}, or a zero-dispersion slope slope@λ₀ according to slope@λ₀=8B.

11. An information processing device for performing the estimation method according to claim 1, the information processing device comprising a processor that executes the estimating of the measurement variation.

12. An information processing device for performing the measurement method according to claim 8, the information processing device comprising a processor that executes the estimating of the measurement variation.

13. The estimation method according to claim 5, wherein the estimating of the measurement variation is performed only when the fiber length of the target optical fiber falls within a range.

14. An information processing device for performing the estimation method according to claim 5, the information processing device comprising a processor that executes the estimating of the measurement variation.
